(19) United States
(12) Patent Application Publication
(10) Pub. No.: US 2021/0398395 A1
(43) Pub. Date: Dec. 23, 2021

(54) Blockchain based voting system for live competitions

(71) Applicant: Jahmeke Rodriquez, Queens Village, NY (US)

(72) Inventor: Jahmeke Rodriquez, Queens Village, NY (US)

(21) Appl. No.: 16/946,351

(22) Filed: Jun. 18, 2020

(51) Int. Cl. G07F 17/32; A63F 13/828; H04L 9/06

(52) U.S. Cl. CPC G07F 17/3288; G07F 17/3276; H04L 2209/38; H04L 9/0643; A63F 13/828

(57) ABSTRACT

Battle Rap currently has no fair voting mechanism to determine the outcome of live rap competitions. Therefore, there is usually no winner or in very rare cases the winner is decided by a select group of judges. The present invention seeks to find a solution to this problem by providing a ‘blockchain’ or decentralized, distributed ledger based voting and gaming system for live competitions.

### CROSS REFERENCE TO RELATED APPLICATIONS

### STATEMENT REGARDING FEDERALLY SPONSORED RESEARCH OR DEVELOPMENT

“Not Applicable”

### REFERENCE TO SEQUENCE LISTING, A TABLE OR A COMPUTER LISTING COMPACT DISK APPENDIX

“Not Applicable”

### BACKGROUND OF THE INVENTION

### Field of Invention

Entertainment & Gaming

### BRIEF SUMMARY OF THE INVENTION

### Problem

Battle Rap currently has no fair voting mechanism to determine the outcome of live rap competitions. Therefore, there is usually no winner or in very rare cases the winner is decided by a select group of judges.

### Solution

The present invention seeks to find a solution to this problem by providing a ‘blockchain’ or decentralized, distributed ledger based voting and gaming system for live competitions. This includes but is not limited to; 1) a decentralized voting mechanism wherein users judge the outcome of live competitions by placing a vote on an encrypted, immutable, and verifiable distributed ledger technology also known as ‘blockchain’ technology, 2) a blockchain based fantasy sports system wherein users select a roster or team of competitors that will be represented by digital assets and compete against other users in a fantasy sports gaming system.

### BRIEF DESCRIPTION OF THE SEVERAL VIEWS OF THE DRAWING

FIG. 1 Software Architecture: This draw8ng depicts the architectural layers of our invention.

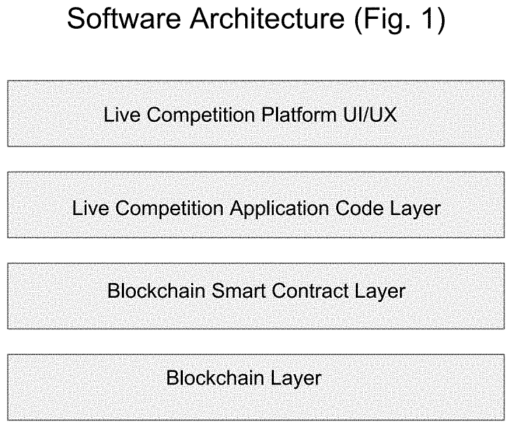

FIG. 2 Live Competition Voting Mechanism: This drawing depicts a user interface example on the invention layout.

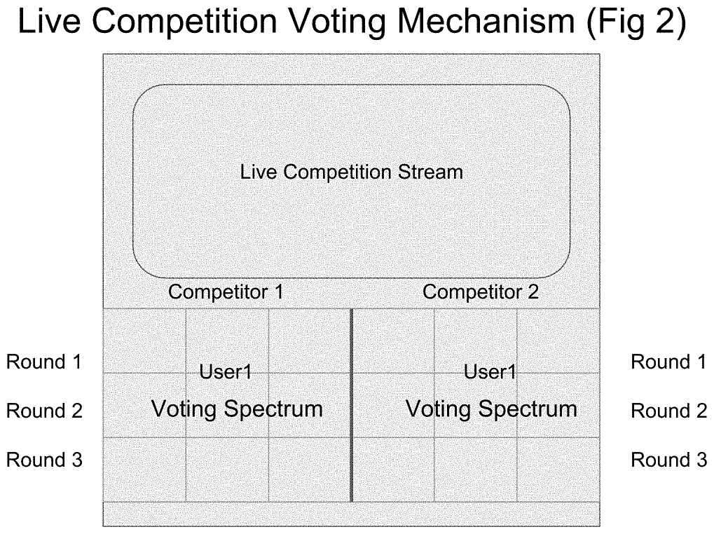

FIG. 3 Live Competition Voting Flow: This drawing depicts the workflow of our invention.

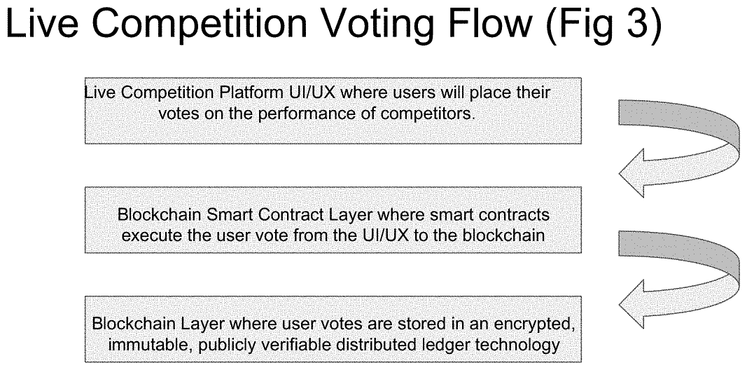

FIG. 4 Fantasy Sports Gaming Mechanism: This drawing depicts the workflow of our fantasy sports gaming mechanism.

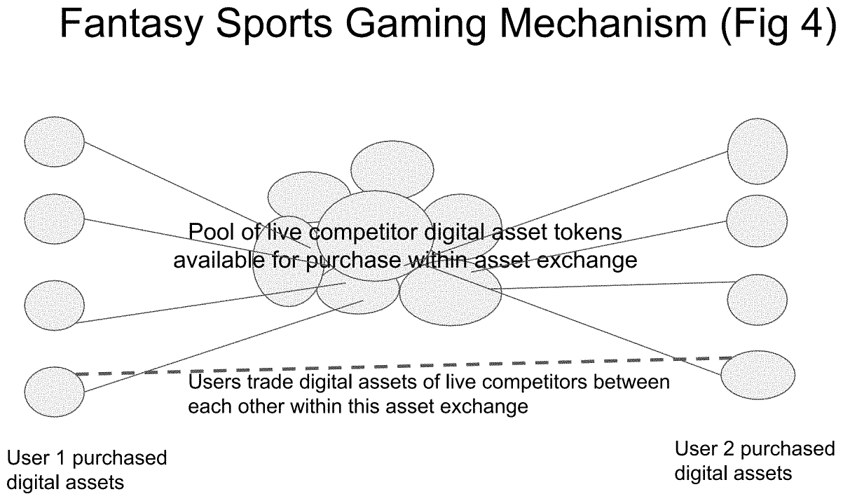

### DETAILED DESCRIPTION OF THE INVENTION

How it works:

Users will watch a live competition and vote on the match or by round, on which competitor they believe won. These votes will simultaneously be recorded onto a decentralized blockchain technology wherein users' votes will be stored on an immutable distributed ledger, encrypted using state of the art cryptography. Once all users votes are collected and tallied by the system, the winner is decided. This ledger will be verifiable using a ledger journal that permissioned network members will have access to.

Another edition of this invention could be where Artificial Intelligence or AI acts as the judge of such competitions by simulating the voting outcome on top of blockchain or distributed ledger technology, these votes will also be encrypted, immutable, and publicly verifiable.

Using the statistical outcomes of these votes, which are generated using blockchain technology, users can participate in a blockchain based fantasy sports gaming system wherein; users create their own roster or team of competitors by purchasing digital assets that represent the live competitors on the platform. Users will then compete in public and private competitions against other users in daily, weekly, monthly and season long competitions. Users will be able to track the performance of their digital assets and be able to buy, sell or trade these digital assets with other users using a blockchain based asset exchange platform that will execute these transactions using smart contracts.

Any transactions of value that occur within the voting system and fantasy sports gaming system can be executed by, but are not limited to; fiat currencies, native platform digital token or cryptocurrency, third party digital tokens or cryptocurrencies, or any other future units of value.

This invention also includes any unforeseen future technological advances that can apply this method.

### CLAIM OR CLAIMS

“Not Applicable”

### SEQUENCE LISTING

“Not Applicable”

### MOST IMPORTANT PREFERRED ASPECTS

Preferably, the voting mechanism for the live broadcasted and/or simulated Artificial Intelligence competitions should be on a blockchain based technology because it provides the level of trust with our users that our statistics are not manipulated and can therefore also provide a statistical database for gaming.

Preferably, the fantasy sports gaming solution should be blockchain based because the ability to represent live competitors as tokenized digital assets allow us to provide a faster, more secure system for fantasy gaming wherein the digital assets that represent the live competitors can be bought, sold and traded across a blockchain based asset exchange, executed by ‘smart contracts’ or code that automatically executes programmed functions.

Preferably, the transactions of value that occur within the voting system and fantasy sports gaming system will be represented by our native platform digital token or cryptocurrency. This is ideal because it provides an opportunity for economic value generation and appreciation of the native platform digital token or cryptocurrency and the overall system which cannot be achieved using traditional units of value.

I claim:

1) A ‘blockchain’ based voting system for live competitions comprising:
a blockchain;
a user-based voting interface programmed on top of said blockchain; and
a streaming portal built into said user-based voting interface, on top of said blockchain for live and pre-recorded content.

2) A blockchain based voting system as in claim 1, wherein an Artificial Intelligence program simulates the voting outcome of said blockchain based voting system.

3) A blockchain based voting system as in claim 1, wherein a technology not yet invented simulates the voting outcome of said blockchain based voting system.

4) A blockchain based fantasy gaming system as in claim 1, wherein said blockchain based voting system stores a digital asset(s) that represents competitor(s).

5) A blockchain based fantasy gaming system as in claim 1, wherein the statistics produced by said blockchain based voting system are indicative of tallied user votes that reflect the performance of a competitor represented as said digital asset(s).

6) A blockchain based fantasy gaming system as in claim 2, wherein said Artificial Intelligence program simulates the voting outcome of said blockchain based voting system and produces said statistics that reflect the performance of competitor(s) represented as said digital asset(s).

7) A blockchain based fantasy gaming system as in claim 3, wherein said technology not yet invented simulates the voting outcome of said blockchain based voting system and produces said statistics that reflect the performance of competitor(s) represented as said digital asset(s).

8) A blockchain based betting system as in claim 1, wherein said statistics produced by said blockchain based voting system are used as basis for user generated betting and wager competitions.

9) A blockchain based betting system as in claim 2, wherein said statistics produced by said Artificial Intelligence program are used as basis for user generated betting and wager competitions.

10) A blockchain based betting system as in claim 3, wherein said statistics produced by said technology not yet invented are used as basis for user generated betting and wager competitions.
